(19) United States
(12) Patent Application Publication
(10) Pub. No.: US 2013/0127335 A1
(43) Pub. Date: May 23, 2013

(54) ELECTROLUMINESCENT DISPLAY DEVICE

(71) Applicants: WINTEK (CHINA) TECHNOLOGY LTD., Dongguan City (CN); WINTEK CORPORATION, Taichung City (TW)

(72) Inventors: Shao-Ju Chang, New Taipei City (TW); Wen-Hong Liu, Taichung City (TW); Cheng-Chieh Hung, Taichung City (TW); Hen-Ta Kang, Taichung City (TW); Chih-Yuan Wang, Taichung City (TW)

(73) Assignees: WINTEK CORPORATION, Taichung City (TW); WINTEK (CHINA) TECHNOLOGY LTD., Dongguan City (CN)

(21) Appl. No.: 13/677,268

(22) Filed: Nov. 14, 2012

(30) Foreign Application Priority Data
Nov. 17, 2011 (TW) 100142161

(51) Int. Cl. H05B 33/04

(52) U.S. Cl. CPC H05B 33/04
USPC 313/512

(57) ABSTRACT

An electroluminescent display device includes a main substrate, an encapsulation substrate, a plurality of display units, a sealant, and at least an atomic layer deposition barrier. The main substrate has a first inner surface and a first outer surface. The encapsulation substrate is disposed oppositely to the main substrate. The encapsulation substrate has a second inner surface and a second outer surface. The display units are disposed on the first inner surface. The sealant is disposed between the main substrate and the encapsulation substrate, and the sealant covers the display units. The atomic layer deposition barrier covers at least one of the second inner surface and the second outer surface.

### BACKGROUND OF THE INVENTION

1. Field of the Invention

The present invention relates to an electroluminescent display device, and more particularly, to an electroluminescent display device with atomic layer deposition (ALD) barrier which is employed for improving the reliability and the life time of the electroluminescent display device.

2. Description of the Prior Art

Because of certain advantages, such as being color filter free, self-lighting, backlight module free, and having low power consumption, the electroluminescent display devices are regarded as a front runner to replace the conventional liquid crystal display device and become the mainstream display products of the next generation. Organic light emitting diode (OLED) display technology may be the most mature technology among all the electroluminescent display technologies.

Glass frits are generally employed in the packaging process in the organic light emitting diode display technology. In the structure of the organic light emitting diode display device with glass fits, hollow spacing exists between two substrates and shrinking problem may occur when the size of the display device becomes larger. Additionally, when the organic light emitting diode display device with glass fits and the touch panel are combined, touch operations may also damage the organic light emitting diode display device with glass frits. Complete encapsulation technologies are therefore developed to overcome the problems described above, and a “dam and fill” technology and a “face seal” technology are the most popular among the complete encapsulation technologies.

Please refer to FIG. 1. FIG. 1 is a schematic diagram illustrating a conventional organic light emitting diode display device made through a dam and fill technology process. As shown in FIG. 1; a conventional organic light emitting diode display device 400 includes a thin film transistor substrate 410, an encapsulation substrate 420, a plurality of display units 430, a dam 460, a liquid sealant 440, and an external circuit unit 470. The thin film transistor substrate 410 has a first inner surface 411 and a first outer surface 412. The encapsulation substrate 420 is disposed oppositely to the thin film transistor substrate 410. The encapsulation substrate 420 has a second inner surface 421 and a second outer surface 422. The second inner surface 421 faces the first inner surface 411. The display units 430 are disposed on the first inner surface 411 of the thin film transistor substrate 410. The liquid sealant 440 is disposed between the thin film transistor substrate 410 and the encapsulation substrate 420 to combine the thin film transistor substrate 410 with the encapsulation substrate 420 and thereby covering the display units 430. The dam 460 is disposed between the thin film transistor substrate 410 and the encapsulation substrate 420, and the dam 460 surrounds the liquid sealant 440. In the dam and fill technology process, the dam 460 is employed to contain the liquid sealant 460, and the liquid sealant 440 may then protect the display units 430. Additionally, in the organic light emitting diode display device 400, the external circuit unit 470 may be electrically connected to the thin film transistor substrate 410 so as to provide display signals to the organic light emitting diode display device 400.

Please refer to FIG. 2 and FIG. 1. FIG. 2 is a schematic diagram illustrating a conventional organic light emitting diode display device made through a face seal technology process. As shown in FIG. 1 and FIG. 2, the liquid sealant 440 and the dam 460 are replaced by a solid sealant 441 in the organic light emitting diode display device 401 made through the face seal technology process. The solid sealant 441 is employed to directly combine the thin film transistor substrate 410 with the encapsulation substrate 420 and protect the display unit 430. The protection performance on the display units may be improved by the dam and fill technology and the face seal technology. However, the moisture blocking ability may still have to be further improved in the dam and fill technology and the face seal technology, especially when plastic substrates are employed as thin film transistor substrate and encapsulation substrate in order to reduce the total volume and weight of the organic light emitting diode display device. Since the plastic substrate is not good at blocking moisture, moisture may penetrate the thin film transistor substrate 410 and the encapsulation substrate 420 made of plastic materials, and the display units 430 may then be damaged by the moisture. Therefore, in the organic light emitting diode display device employing plastic substrates and complete encapsulation technologies, the moisture blocking ability still has to be further improved.

### SUMMARY OF THE INVENTION

It is one of the objectives of the present invention to provide an electroluminescent display device. Single layer atomic layer deposition (ALD) barriers or multi-layer ALD barriers are employed to improve the reliability of the electroluminescent display device made with complete encapsulation technology.

To achieve the purposes described above, a preferred embodiment of the present invention provides an electroluminescent display device. The electroluminescent display device includes a main substrate, an encapsulation substrate, a plurality of display units, a sealant, and at least an atomic layer deposition barrier. The main substrate has a first inner surface and a first outer surface. The encapsulation substrate is disposed oppositely to the main substrate. The encapsulation substrate has a second inner surface and a second outer surface. The second inner surface faces the first inner surface, and the second outer surface faces a direction opposite to the first outer surface. The display units are disposed on the first inner surface of the main substrate. The sealant is disposed between the main substrate and the encapsulation substrate, and the sealant covers the display units. The atomic layer deposition barrier covers at least one of the second inner surface and the second outer surface.

In the electroluminescent display device of the present invention, a single layer or a multi-layer ALD barrier is disposed in the inner surfaces of the substrates or at outer parts of the electroluminescent display device in order to improve the moisture blocking ability which may be influenced by the materials of the substrates and the sealant. The reliability of the electroluminescent display device may then be enhanced, and a touch positioning function may also be integrated into the electroluminescent display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams illustrating a conventional organic light emitting diode display device.

FIG. 3 is a schematic diagram illustrating an electroluminescent display device according to a first preferred embodiment of the present invention.

FIG. 4 and FIG. 5 are schematic diagrams illustrating an electroluminescent display device according to a second preferred embodiment of the present invention.

FIG. 6 is a schematic diagram illustrating an electroluminescent display device according to a third preferred embodiment of the present invention.

FIG. 7 is a schematic diagram illustrating an electroluminescent display device according to a fourth preferred embodiment of the present invention.

FIG. 8 is a schematic diagram illustrating an electroluminescent display device according to a fifth preferred embodiment of the present invention.

FIG. 9 is a schematic diagram illustrating an electroluminescent display device according to a sixth preferred embodiment of the present invention.

FIG. 10 is a schematic diagram illustrating an electroluminescent display device according to a seventh preferred embodiment of the present invention.

FIG. 11 is a schematic diagram illustrating an electroluminescent display device according to an eighth preferred embodiment of the present invention.

FIG. 12 is a schematic diagram illustrating an electroluminescent display device according to a ninth preferred embodiment of the present invention.

FIG. 13 is a schematic diagram illustrating an electroluminescent display device according to a tenth preferred embodiment of the present invention.

FIG. 14 is a schematic diagram illustrating an electroluminescent display device according to an eleventh preferred embodiment of the present invention.

FIG. 15 is a schematic diagram illustrating an electroluminescent display device according to a twelfth preferred embodiment of the present invention.

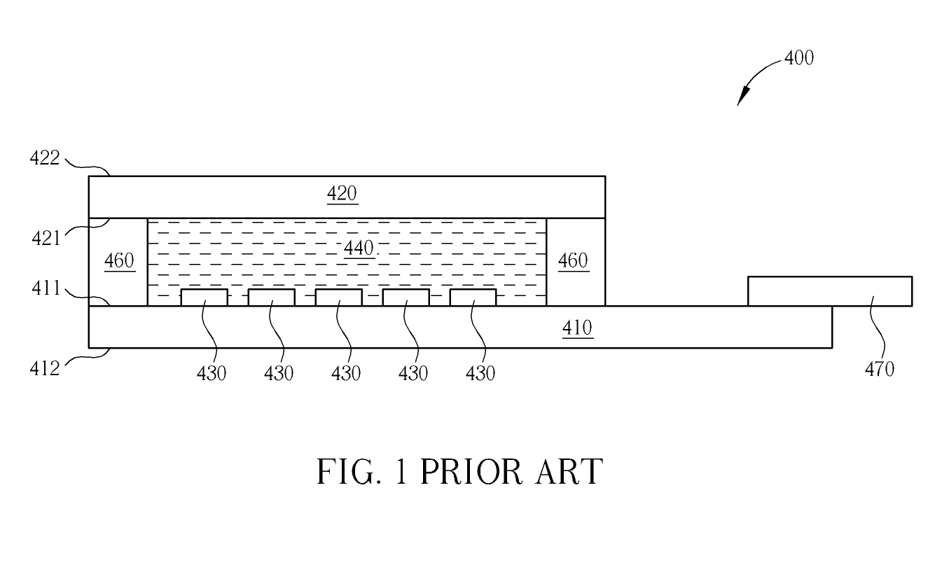

### DETAILED DESCRIPTION

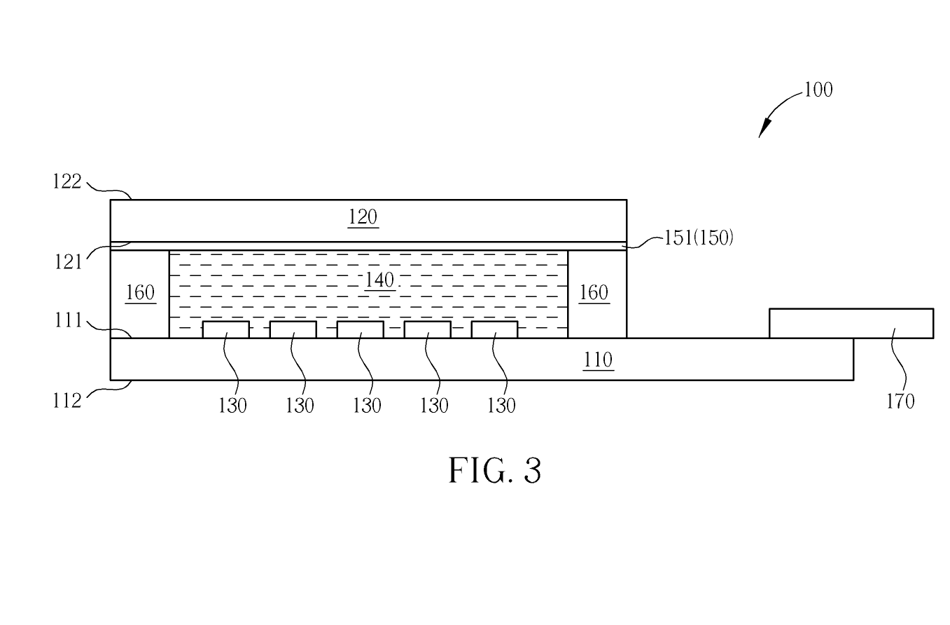

Please refer to FIG. 3. FIG. 3 is a schematic diagram illustrating an electroluminescent display device according to a first preferred embodiment of the present invention. Please note that the figures are only for illustration and the figures may not be to scale. The scale may be further modified according to different design considerations. As shown in FIG. 3, an electroluminescent display device 100 includes a main substrate 110, an encapsulation substrate 120, a plurality of display units 130, a sealant 140, and at least an atomic layer deposition (ALD) barrier 150. The main substrate 110 has a first inner surface 111 and a first outer surface 112. The encapsulation substrate 120 is disposed oppositely to the main substrate 110. The encapsulation substrate 120 has a second inner surface 121 and a second outer surface 122. The second inner surface 121 faces the first inner surface 111 and the second outer surface 122 faces a direction opposite to the first outer surface 112. The ALD barrier 150 may cover at least one of the second inner surface 121 and the second outer surface 122. In the present invention, at least one of the main substrate 110 and the encapsulation substrate 120 may be a plastic substrate with a surface covered with the ALD barrier 150, but not limited thereto. The plastic substrate may be introduced into the electroluminescent display device 100 in order to reduce the total weight of the electroluminescent display device 100. Additionally, the main substrate 110 may include a thin film transistor substrate, or other appropriate substrate capable of driving the display units 130. The display unit 130 may be a top emission type organic light emitting diode (OLED) or a bottom emission type OLED, but the electroluminescent display device of the present invention is not limited to this, and other kinds of display units with similar light emitting properties may also be employed in the electroluminescent display device of the present invention. The thin film transistor substrate mentioned above may include an amorphous silicon thin film transistor (a-Si TFT) substrate, a poly-silicon thin film transistor (poly-Si TFT) substrate, an oxide semiconductor TFT substrate, or other kinds of TFT substrates. Additionally, the encapsulation substrate 120 may include polyethylene terephthalate (PET) substrate, polyethersulfone (PES) substrate, polyimide (PI) substrate, polycarbonate (PC) substrate, polyethylene naphthalate (PEN) substrate, polymethyl methacrylate (PMMA) substrate, or the substrates mentioned above coated with organic or inorganic functional coatings, but not limited thereto. The display units 130 are disposed on the first outer surface 111 of the main substrate 110. The sealant 140 is disposed between the main substrate 110 and the encapsulation substrate 120, and the sealant 140 covers the display units 130. In this embodiment, the sealant 140 may include liquid polymer sealants, solid polymer sealants, or other appropriate transparent sealants. Additionally, the sealant 140 may also include light-curable or thermal-curable polymer materials such as epoxy materials, acrylic materials and silicone. The sealant 140 may accordingly be solidified to protect the display units 130.

As shown in FIG. 3, the ALD barrier 150 includes a first ALD barrier 151, and the first ALD barrier 151 covers the second inner surface 121. In this embodiment, the ALD barrier 150 may include oxide or nitride. For example, the ALD barrier 150 may include silicon oxide (SiO₂), aluminum oxide (Al₂O₃), zirconium oxide (ZrO₂), titanium oxide (TiO₂), barium titanium oxide (BaTiO₃), hafnium oxide (HfO₂), tantalum oxide (Ta₂O₅) and silicon nitride (Si₃N₄), but the ALD barrier 150 of the present invention is not limited to this and may include other appropriate material capable of blocking moisture. In addition, it is worth noting that the ALD barrier of the present invention may be preferably formed by processes such as atomic layer deposition (ALD), molecular beam epitaxy (MBE), or metal organic chemical vapor deposition (MOCVD), but the present invention is not limited to this and other processes capable of forming ALD barriers with high density may also be adopted in this invention. In this embodiment, a thickness of the ALD barrier 150 is substantially between 10 nanometers and 200 nanometers, but the present invention is not limited to this and the thickness of the ALD barrier may be further adjusted to ensure good moisture blocking performances without interfering with the normal operation of the electroluminescent display device.

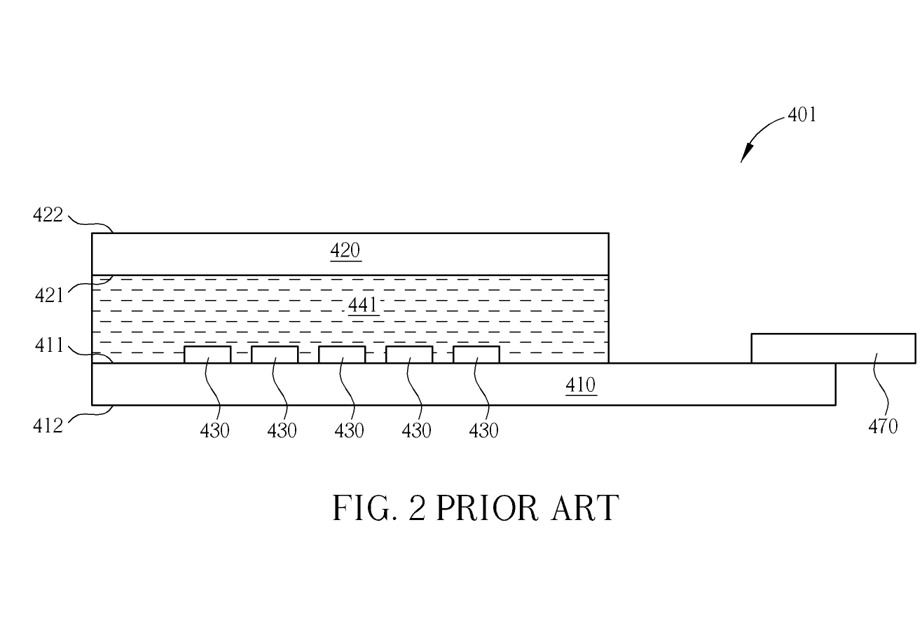

As shown in FIG. 2, the electroluminescent display device 100 may further include a dam 160 disposed between the main substrate 110 and the encapsulation substrate 120. The dam 160 at least partially surrounds the sealant 140. The dam 160 in this embodiment is mainly employed to contain the sealant 140, especially when the sealant 140 is in liquid phase, but the present invention is not limited to this and the dam may be employed to contain sealants in other conditions. Additionally, the electroluminescent display device 100 may further include an external circuit unit 170 partially electrically connected with the main substrate 110 to provide display signals to the main substrate 110. In this embodiment, the external circuit unit 170 may include flexible printed circuit (FPC) or integrated circuit (IC) unit, but not limited thereto.

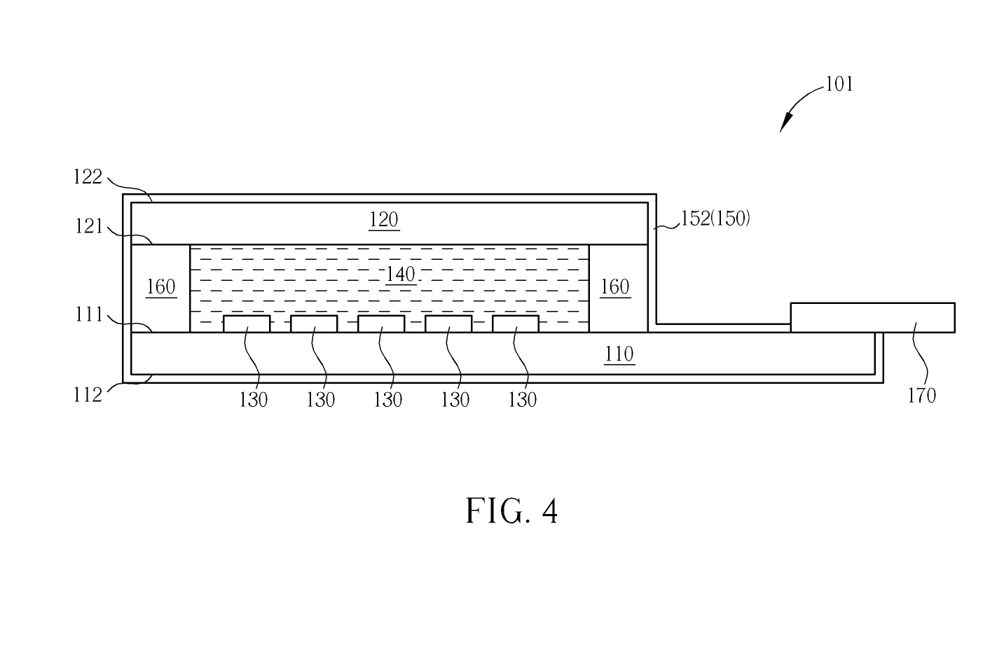

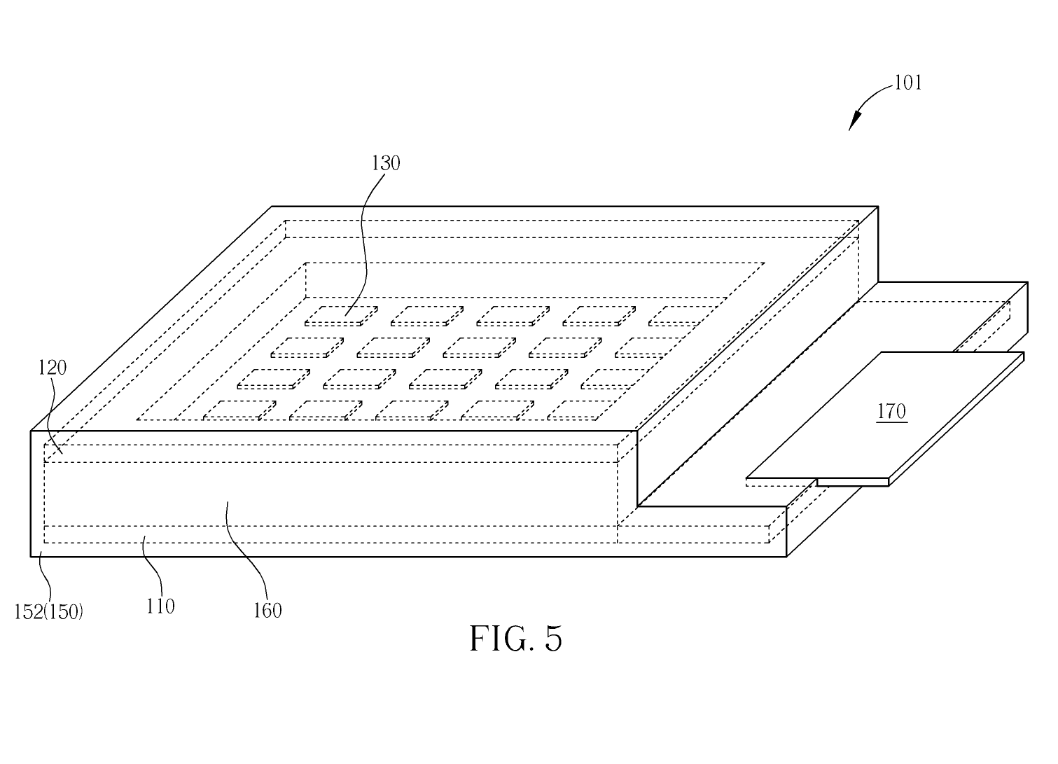

Please refer to FIG. 4 and FIG. 5. FIG. 4 and FIG. 5 are schematic diagrams illustrating an electroluminescent display device 101 according to a second preferred embodiment of the present invention. FIG. 4 is a side view diagram, and FIG. 5 is a stereoscopic diagram. As shown in FIG. 4 and FIG. 5, the difference between the electroluminescent display device 101 of this embodiment and the electroluminescent display device 100 of the first preferred embodiment is that the ALD barrier 150 in this embodiment includes a second ALD barrier 152. The second ALD barrier 152 covers the second outer surface 122 of the encapsulation substrate 120. In addition, the second ALD barrier 152 at least partially covers the first outer surface 112 and the first inner surface 111, and the second ALD barrier 152 surrounds the sealant 140. It is worth noting that the second ALD barrier 152 preferably covers only a part of the first inner surface 111, and the external circuit unit 170 may then be able to be effectively connected to the main substrate 110. The display signals may accordingly be provided to the electroluminescent display device 101 to display images. In other words, to ensure better protection performances, the second ALD barrier 152 preferably covers all the outmost part of the electroluminescent display device 101, except the area covered by the external circuit unit 170. More specifically, apart from the area which is going to be connected to the external circuit unit 170 on the main substrate 110, the second ALD barrier 152 may totally cover the second outer surface 122 and the first outer surface 112, partially cover the first inner surface 111 and the dam 160, and surround the sealant 140 to effectively enhance the moisture blocking performances of the electroluminescent display device 101. In this embodiment, the second ALD barrier 152 may be formed before or after the process of combining the external circuit unit 170 and the main substrate 110, and the second ALD barrier 152 may selectively cover at least a part of the external circuit unit 170 for protection purposes. Apart from the ALD barrier 150 of the electroluminescent display device 101, the other components and the material properties of this embodiment are similar to the first preferred embodiment detailed above and will not be redundantly described.

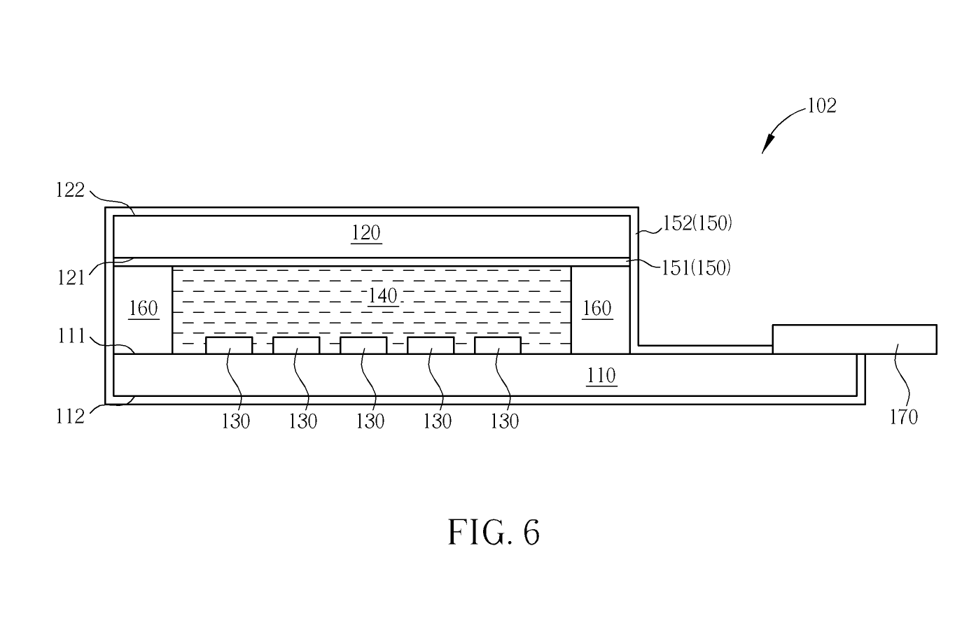

Please refer to FIG. 6. FIG. 6 is a schematic diagram illustrating an electroluminescent display device 102 according to a third preferred embodiment of the present invention. As shown in FIG. 6, the difference between the electroluminescent display device 102 of this embodiment and the electroluminescent display device 100 of the first preferred embodiment is that the ALD barrier 150 in this embodiment includes a first ALD barrier 151 and a second ALD barrier 152. The first ALD barrier 151 covers the second inner surface 121 of the encapsulation substrate 120 and the second ALD barrier 152 covers the second outer surface 122 of the encapsulation substrate 120. Additionally, the second ALD barrier 152 at least partially covers the first outer surface 112 and the first inner surface 111, and the second ALD barrier 152 surrounds the sealant 140. Apart from the second ALD barrier 152 of the electroluminescent display device 102, other components and material properties of this embodiment are similar to the first preferred embodiment detailed above and will not be redundantly described.

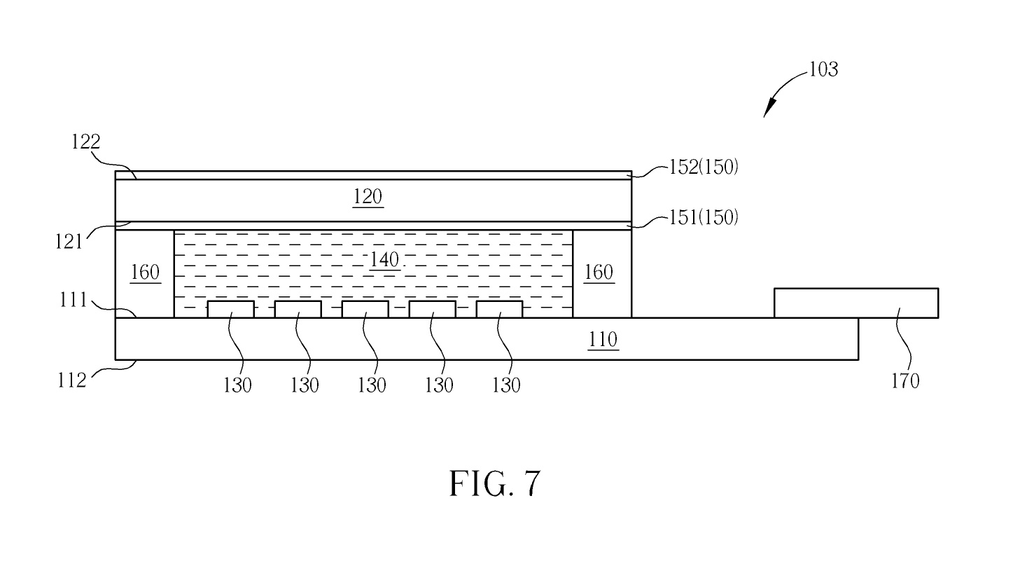

Please refer to FIG. 7. FIG. 7 is a schematic diagram illustrating an electroluminescent display device 103 according to a fourth preferred embodiment of the present invention. As shown in FIG. 7, the difference between the electroluminescent display device 103 of this embodiment and the electroluminescent display device 102 of the third preferred embodiment is that the second ALD barrier 152 in this embodiment covers only the second outer surface 122 of the encapsulation substrate 120. In other words, the first ALD barrier 151 and the second ALD barrier 152 may be formed on the second inner surface 121 and the second outer surface 122 of the encapsulation substrate 120 before combining the encapsulation substrate 120 and the main substrate 110, but the present invention is not limited to this and other appropriate process steps and sequence may be adopted to form the first ALD barrier 151 and the second ALD barrier 152.

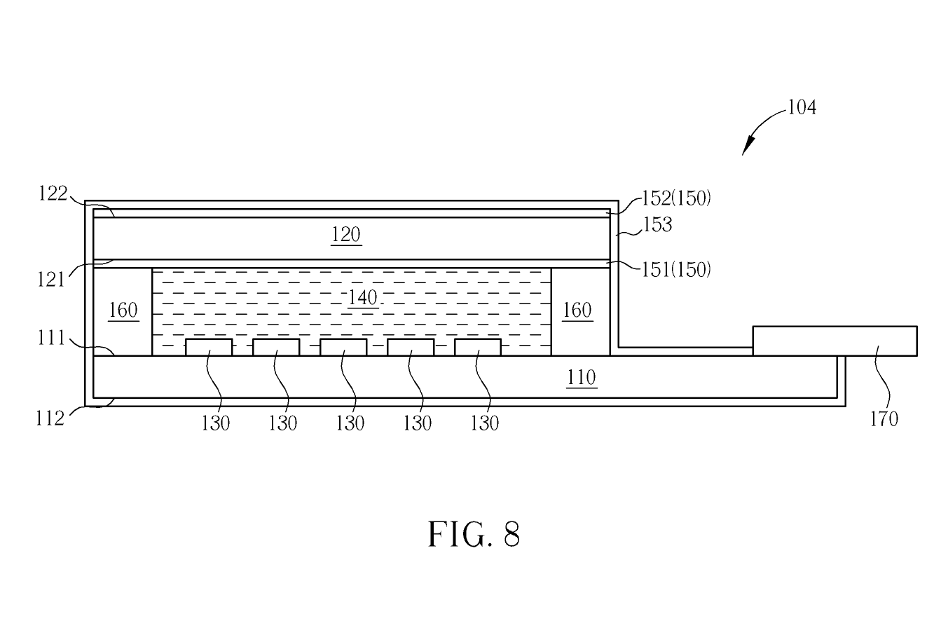

Please refer to FIG. 8. FIG. 8 is a schematic diagram illustrating an electroluminescent display device 104 according to a fifth preferred embodiment of the present invention. As shown in FIG. 8, the difference between the electroluminescent display device 104 of this embodiment and the electroluminescent display device 103 of the fourth preferred embodiment is that the electroluminescent display device 104 further includes a third ALD barrier 153. The third ALD barrier 153 covers the second ALD barrier 152. In addition, the third ALD barrier 153 covers the first outer surface 112, at least partially covers the first inner surface 111, and surrounds the sealant 140. The property of blocking moisture in the electroluminescent display device 104 may be further enhanced by the third ALD barrier 153.

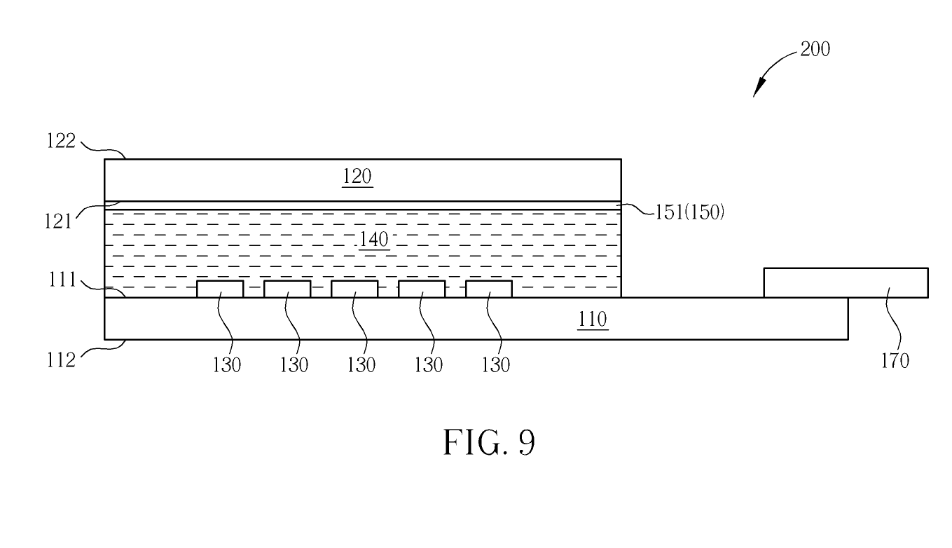

Please refer to FIG. 9. FIG. 9 is a schematic diagram illustrating an electroluminescent display device 200 according to a sixth preferred embodiment of the present invention. As shown in FIG. 9, the difference between the electroluminescent display device 200 of this embodiment and the electroluminescent display device 100 of the first preferred embodiment is that there is no dam 160 in the electroluminescent display device 200. The sealant 140 is employed to directly combine the main substrate 110 with the encapsulation substrate 120 and protect the display units 130. Apart from the dam-free design of the electroluminescent display device 200, the other components and the material properties of this embodiment are similar to the first preferred embodiment detailed above and will not be redundantly described.

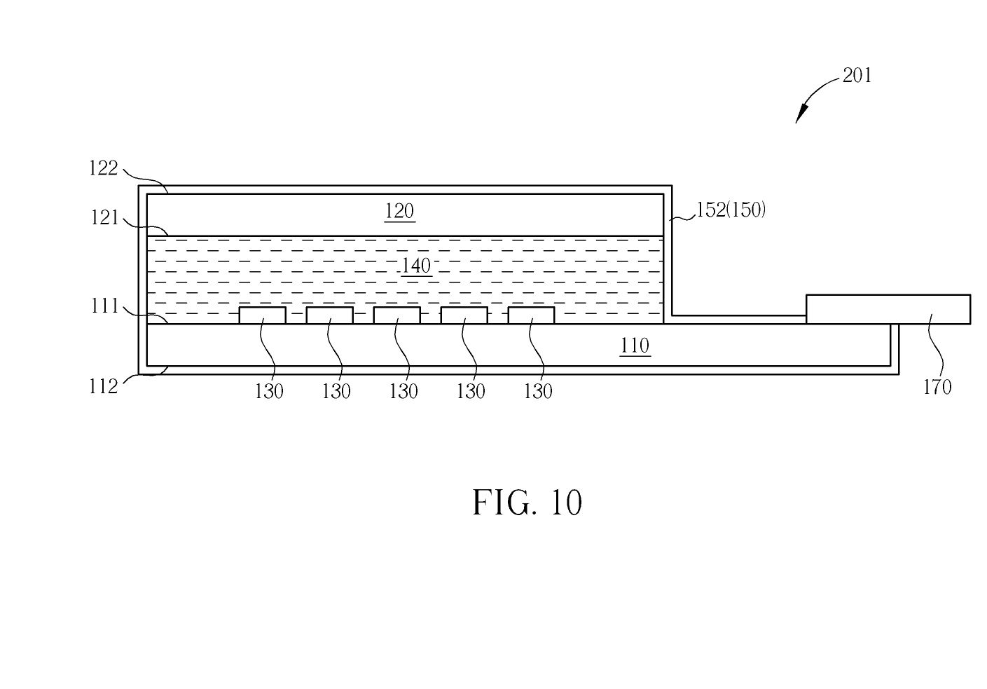

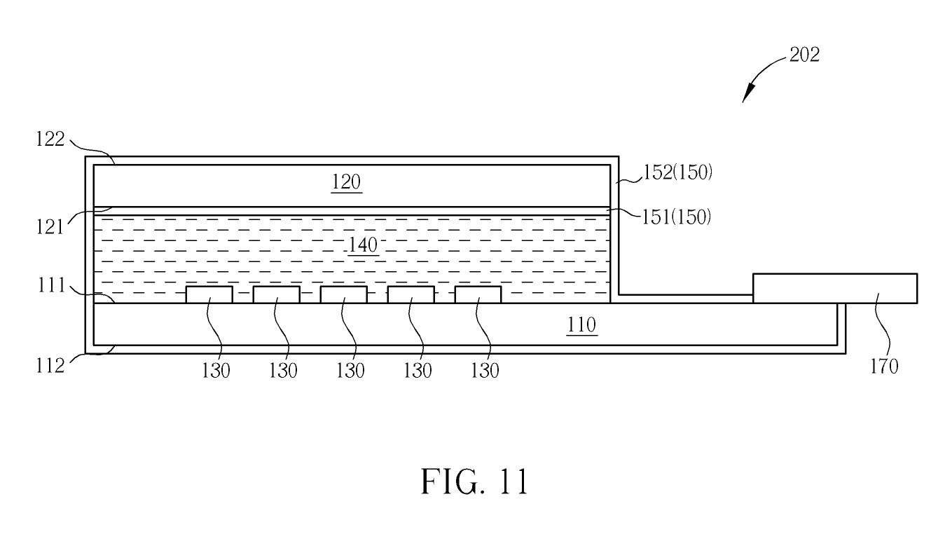

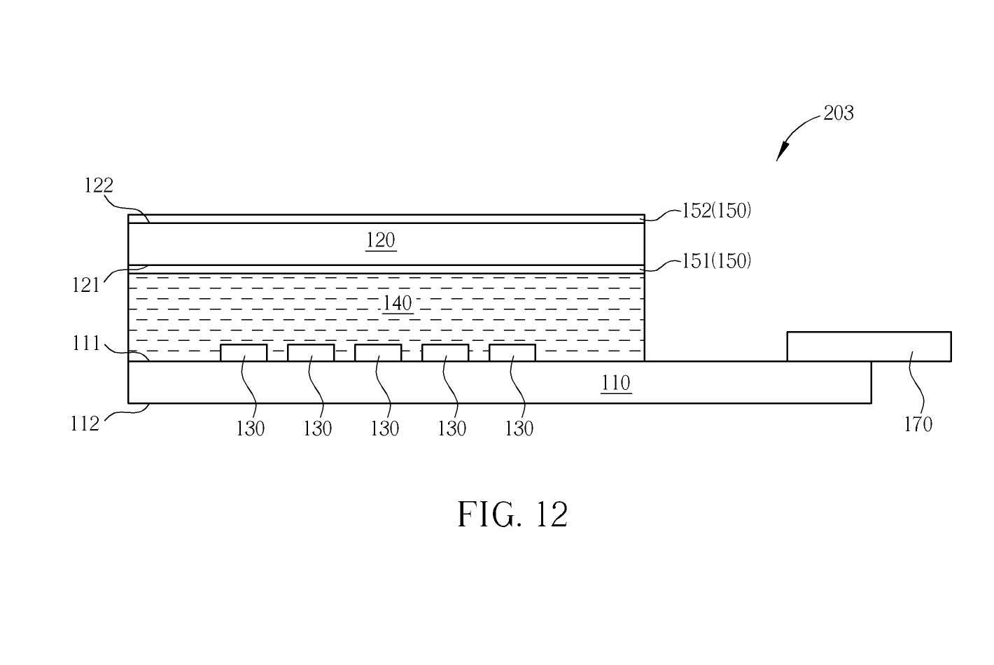

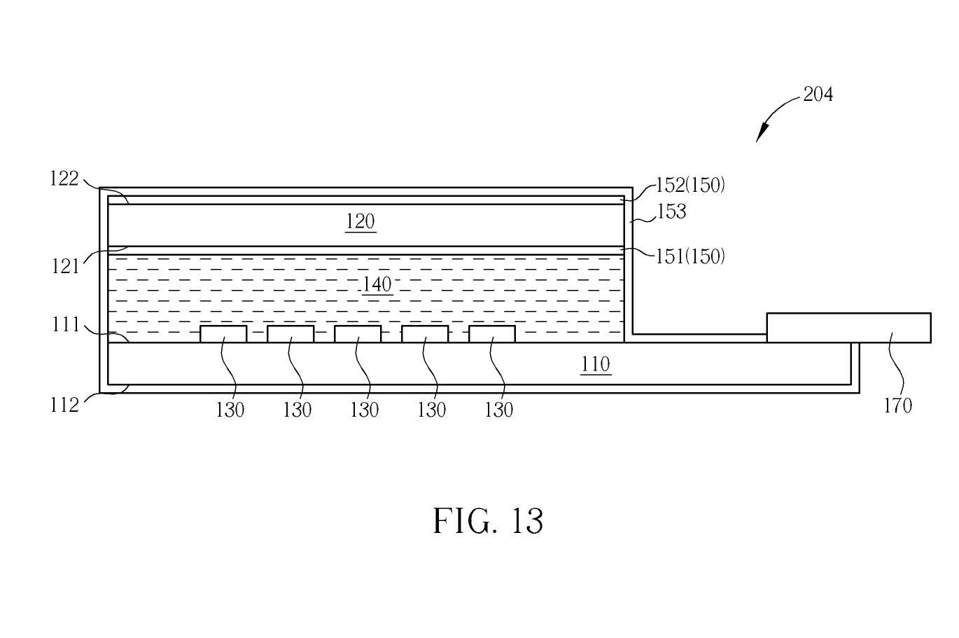

Please refer to FIGS. 10-13. FIG. 10 is a schematic diagram illustrating an electroluminescent display device 201 according to a seventh preferred embodiment of the present invention. FIG. 11 is a schematic diagram illustrating an electroluminescent display device 202 according to an eighth preferred embodiment of the present invention. FIG. 12 is a schematic diagram illustrating an electroluminescent display device 203 according to a ninth preferred embodiment of the present invention. FIG. 13 is a schematic diagram illustrating an electroluminescent display device 204 according to a tenth preferred embodiment of the present invention. As shown in FIGS. 10-13, apart from the dam-free designs in the electroluminescent display device 201, the electroluminescent display device 202, the electroluminescent display device 203, and the electroluminescent display device 204, the other components and the material properties of these embodiments are respectively similar to the second preferred embodiment, the third preferred embodiment, the fourth preferred embodiment, and the fifth preferred embodiment detailed above and will not be redundantly described.

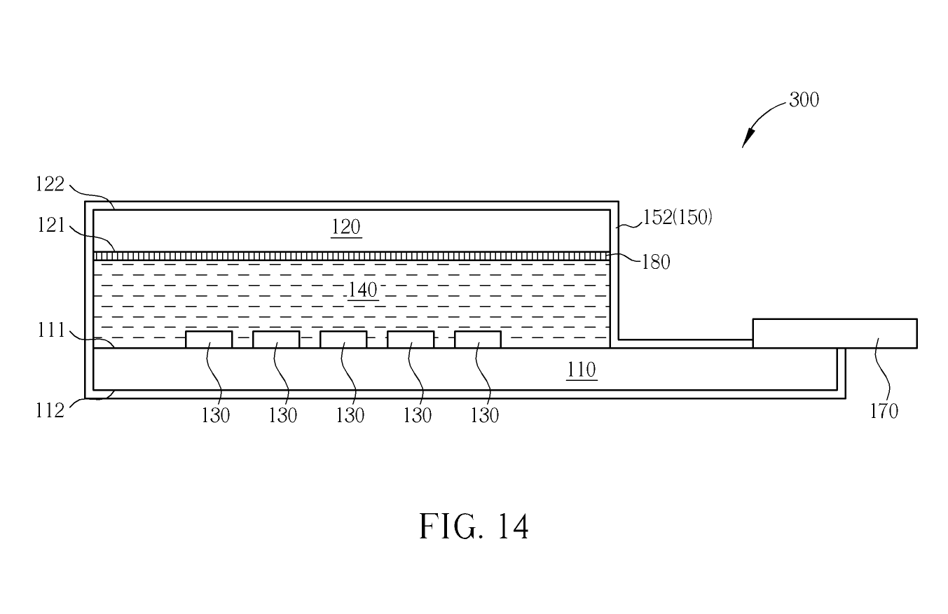

Please refer to FIG. 14. FIG. 14 is a schematic diagram illustrating an electroluminescent display device 300 according to an eleventh preferred embodiment of the present invention. As shown in FIG. 14, the difference between the electroluminescent display device 300 of this embodiment and the electroluminescent display device 201 of the seventh preferred embodiment is that the electroluminescent display device 300 further includes at least one touch sensing device 180 disposed on the second inner surface 121. Additionally, the second ALD barrier 152 in this embodiment covers the first outer surface 112 and the second outer surface 122, at least partially covers the first inner surface 111, and surrounds the sealant 140. The electroluminescent display device 300 may be a touch display device according to the disposition of the touch sensing device 180. The sealant 140 is disposed between the touch sensing device 180 and the display units 130, and the display units 130 may not be damaged by touch operations especially when the encapsulation substrate 120 is a flexible substrate. In other words, the touch function may be integrated into the electroluminescent display device in this embodiment, and the practicability and the reliability of the electroluminescent display device may also be enhanced.

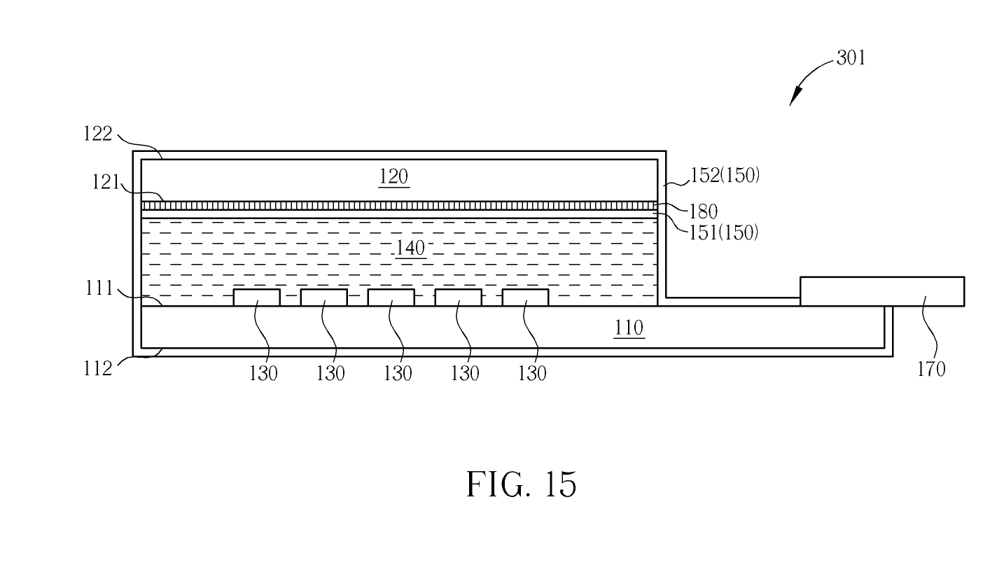

Please refer to FIG. 15. FIG. 15 is a schematic diagram illustrating an electroluminescent display device 301 according to a twelfth preferred embodiment of the present invention. As shown in FIG. 15, the difference between the electroluminescent display device 301 of this embodiment and the electroluminescent display device 300 of the eleventh preferred embodiment is that the ALD barrier 150 in this embodiment further includes a first ALD barrier 151 covering the touch sensing device 180. In other words, a manufacturing method of the electroluminescent display device 301 in this embodiment may include the following steps. The touch sensing device 180 may be formed on the second inner surface 121 of the encapsulation substrate 120, and the first ALD barrier 151 may then be formed on the touch sensing device 180. Subsequently, the encapsulation substrate 120 with the touch sensing device 180 and the first ALD barrier 151 may then be combined with the main substrate 110. The second ALD barrier 152 may be formed after combining the encapsulation substrate 120 with the main substrate 110. The present invention is not limited to the process steps mentioned above and other appropriate process steps and sequence may be adopted to form the first ALD barrier 151 and the second ALD barrier 152. It is worth noting that the touch sensing device may also be disposed in the electroluminescent display devices of the preferred embodiments mentioned above.

To summarize the above descriptions, in the present invention, the single layer or the multi-layer ALD barrier is disposed between the layers in the electroluminescent display device or disposed at the outer part of the electroluminescent display device to improve the moisture blocking ability, which may be influenced by the materials of the substrates and the sealant used. The sealant is employed to protect the display units. The reliability of the electroluminescent display device may then be enhanced, and a touch positioning function may also be integrated into the electroluminescent display device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electroluminescent display device, comprising:
a main substrate, the main substrate having a first inner surface and a first outer surface;
an encapsulation substrate, disposed oppositely to the main substrate, wherein the encapsulation substrate has a second inner surface and a second outer surface, the second inner surface faces the first inner surface, and the second outer surface faces a direction opposite to the first outer surface;
a plurality of display units, disposed on the first inner surface of the main substrate;
a sealant, disposed between the main substrate and the encapsulation substrate, wherein the sealant covers the display units; and
at least one atomic layer deposition (ALD) barrier, covering at least one of the second inner surface and the second outer surface.

2. The electroluminescent display device of claim 1, wherein at least one of the main substrate and the encapsulation substrate is a plastic substrate with a surface covered by the ALD barrier.

3. The electroluminescent display device of claim 1, wherein the ALD barrier comprises a first ALD barrier and the first ALD barrier covers the second inner surface.

4. The electroluminescent display device of claim 1, wherein the ALD barrier comprises a second ALD barrier and the second ALD barrier covers the second outer surface.

5. The electroluminescent display device of claim 4, wherein the second ALD barrier at least partially covers the first outer surface and the first inner surface, and the second ALD barrier surrounds the sealant.

6. The electroluminescent display device of claim 4, further comprising a third ALD barrier covering the second ALD barrier, wherein the third ALD barrier at least partially covers the first outer surface and the first inner surface, and the third ALD barrier surrounds the sealant.

7. The electroluminescent display device of claim 1, further comprising a dam, disposed between the main substrate and the encapsulation substrate, wherein the dam at least partially surrounds the sealant.

8. The electroluminescent display device of claim 1, wherein the ALD barrier includes oxide or nitride.

9. The electroluminescent display device of claim 1, wherein the main substrate includes a thin film transistor substrate, and the thin film transistor substrate includes an amorphous silicon thin film transistor substrate, a poly silicon thin film transistor substrate, or an oxide thin film transistor substrate.

10. The electroluminescent display device of claim 1, wherein the encapsulation substrate includes an organic functional coating or an inorganic functional coating.

11. The electroluminescent display device of claim 1, further comprising at least one touch sensing device, disposed on the second inner surface.
